(19) United States
(12) Patent Application Publication
(10) Pub. No.: US 2007/0190316 A1
(43) Pub. Date: Aug. 16, 2007

(54) EMI shielding laminate and method of making same

(75) Inventor: Arnis Kazakevics, South Melbourne (AU)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: LAMINEX GROUP PTY LIMITED

(21) Appl. No.: 11/706,774

(22) Filed: Feb. 15, 2007

(30) Foreign Application Priority Data
Feb. 15, 2006 (AU) 2006900744

(51) Int. Cl. B32B 15/04; B32B 27/08; B32B 29/00; B32B 15/20

(52) U.S. Cl. 428/336; 428/457; 428/537.5; 428/531; 156/307.1

(57) ABSTRACT

A laminate having electromagnetic shielding properties, said laminate including two or more layers adhered together with resin under application of heat and pressure, wherein at least one of said layers includes a substrate having deposited thereon a metal-containing coating. The invention is also a method of manufacturing a laminate having electromagnetic shielding properties including the steps: (a) depositing a metal-containing coating onto a substrate to form a metal coated substrate, (b) incorporating said metal coated substrate into a laminate assembly having 10 at least one other layer, (c) adhering said metal coated substrate to said at least one other layer using a curable resin to form an adhered laminate assembly, and (d) subjecting said adhered laminate assembly to heat and pressure to cure said resin and thereby form said laminate.

### CROSS-REFERENCES TO RELATED APPLICATIONS

This application claims the benefit under 35 U.S.C. §119 of Australian Patent Application No. 2006900744, filed on Feb. 15, 2006, the disclosure of which is incorporated herein by reference.

### FIELD OF THE INVENTION

The present invention relates to electromagnetic shielding laminates. More particularly the invention relates to laminates which may be applied to surfaces of articles or buildings and which demonstrate electromagnetic interference (“EMI”) shielding properties. The invention also relates to methods of making such laminates.

### BACKGROUND OF THE INVENTION

Laminates, especially decorative laminates, having electrical conductive properties are known.

Laminates having electromagnetic shielding properties may be useful in the construction of floors, walls, partitions, ceilings and furniture of rooms or buildings where electromagnetic interference needs to be either kept out or retained within the room or building. For example, rooms housing sensitive medical imaging equipment, or working spaces where interference by telecommunications signals, or the ability of a third party to intercept a telecommunications transmission from outside the space, may need shielding.

According to the US Department of Defense, the behavior of conductive materials in respect of their ability to conduct electrostatic charges can be broken into the following categories based on surface electrical resistance in ohms/square:
Anti-static—greater than I 0˜
Static Dissipative—between 106 and I 0˜
Conductive—less than 106

The terms anti-static, dissipative and conductive as used in this specification shall generally refer to the above definitions. It will be appreciated however that there may be overlap between the respective ranges, for example a laminate may still be considered to have dissipative properties if it has a surface resistance in ohms/square of slightly greater than io˜.

It would be desirable to provide laminates, such as high pressure, continuously pressed 5 or low pressure decorative laminates with a level of conductivity suitable for electromagnetic shielding properties. It would also be desirable for such EMI shielding laminates to optionally also have dissipative and/or antistatic properties. It would further be desirable to make such laminates without significant modification to the laminating process.

### SUMMARY OF THE INVENTION

According to the present invention, there is provided a laminate having electromagnetic shielding properties, said laminate including two or more layers adhered together with resin under application of heat and pressure, wherein at least one of said layers comprises a substrate having deposited thereon a metal-containing coating.

The present invention also provides a method of manufacturing a laminate having electromagnetic shielding properties comprising the steps:

(a) depositing a metal-containing coating onto a substrate to form a metal coated substrate,

(b) incorporating said metal coated substrate into a laminate assembly having at least one other layer,

(c) adhering said metal coated substrate to said at least one other layer using 25 a curable resin to form an adhered laminate assembly, and

(d) subjecting said adhered laminate assembly to heat and pressure to cure said resin and thereby form said laminate.

The present invention further provides a method of manufacturing a laminate having 30 electromagnetic shielding properties including the step of depositing a thin metal containing coating onto a surface of a laminate.

### DETAILED DESCRIPTION OF THE INVENTION

The laminate may also have antistatic and/or static dissipative properties.

The laminate may be a high pressure laminate (HPL), continuously pressed laminate (CPL) or low pressure laminate (LPL), the construction of each being generally known in the field. The laminate may additionally be a decorative laminate.

Preferably the resins are resins conventionally used in the manufacture of decorative 10 laminates especially high-pressure laminates. Such resins, when uncured, are typically resin solutions, usually aqueous or alcohol solutions, or combinations of both. The resins may include amino formaldehyde resins and phenolic resins and combinations of these resins and any derivatives of these resins as may be suitable for preparation of low pressure, continuously pressed and high pressure laminates. Other suitable resins or polymers that are compatible with formaldehyde-based resins may also be used in the laminate.

Typically the substrate is semi-permeable and may be paper, fabric or a textile. Preferably the semi-permeable substrate is a paper, more preferably a paper which is conventionally used in the manufacture of decorative high-pressure laminates. For example, the paper may be an overlay paper having a weight of between 18 and 80 gsm although it could be any paper or substrate that can absorb or be coated with resin and be pressed into a laminate.

Paper such as overlay papers are normally made from cellulose pulp and contain small quantities of melamine formaldehyde resin or similar wet strength additives. These types of papers have sufficient wet strength to enable impregnation with formaldehyde based resins and when cured during lamination these papers tend to become relatively transparent. Often these papers are applied to the face of decorative laminates to protect the surface against wearing. Preferably the semi-permeable substrate is entirely saturated by the resin.

In the case of LPL, the laminate structure typically comprises one or more (sometimes up to three) layers of resin impregnated paper on either side of a wood based board, which are heated and compressed together. Typically at least one of the paper layers is a decorative paper. The resin is typically a melamine formaldehyde resin. Preferably, where the laminate is to be a LPL, the laminate assembly is pressed at a specific pressure of greater than about 15 bar to about 40 bar, and is typically simultaneously heated at a temperature between 130° C. and 180° C.

In the case of HPL, the laminate comprises a minimum of two layers of resin impregnated paper. Typically, the laminate will include an outer, clear protective overlay layer, an intermediate decorative layer and a substrate comprising one or more layers of paper, preferably Kraft paper. The resin used to impregnate the overlay and decorative layers is preferably clear and is usually melamine formaldehyde. The resin used to impregnate the substrate layers is typically a phenol formaldehyde resin. Preferably, where the laminate is to be a HPL, the laminate assembly is pressed at a specific pressure of greater than about 50 bar, such as between 60 and 100 bars.

Typically the high-pressure lamination process also includes heating to between 120° C. and 160° C.

In the case of CPL, the laminate is similar in construction to HPL but is typically thinner. A CPL laminate is formed on a continuous double belted press. It typically comprises a minimum of two paper layers such as a decorative layer and a substrate layer (usually Kraft paper) and optionally a protective overlay layer. Where the laminate is to be a CPL, the laminate assembly can be pressed over a wide range of specific pressures (such as from 15 to 80 bar) and is typically heated at a temperature from about 120 to 160° C.

Preferably the metal containing layer comprises aluminum. More preferably, the metal containing layer is permeable.

The metal containing layer is typically applied to the substrate by vapor deposition. The 30 vapor deposition may be by way of chemical vapor deposition (CVD) or physical vapor deposition (PVD).

As used herein, the term PVD means generally a technique for depositing a thin coating of material by physical means, and includes such techniques as evaporative deposition, sputtering and pulsed laser deposition.

As used herein, the term CVD means a chemical process for depositing a thin film and typically involves reaction and/or decomposition of one or more volatile precursors on a substrate surface in order to produce the desired deposit.

In the laminate of the present invention, it is preferred that the metal containing layer on 10 the substrate is deposited using PVD. More preferably, the metal containing layer is applied using an evaporator, more preferably by using a thermal evaporator. The vaporized metal is then deposited on the substrate. It has been found that PVD using an evaporator advantageously enables rapid deposition of the metal containing layer—for example at a rate of around 1000 m/min. By contrast another PVD method termed sputtering is typically very slow, e.g. 1-Sm/mm, and is not preferred for this reason.

One advantage of using a vapor deposition process is that the permeability of the metal containing layer deposited by it can be more effectively controlled. Accordingly the permeability of the metal coated on the substrate can be sufficient to allow impregnation of resin through the metal layer and into the substrate, if required, during the subsequent lamination process. Another advantage of using vapor deposition is that the thickness of the coating can be more easily controlled. The process is also generally rapid and is more efficient overall as compared to conventional metal coating processes such as metal foils or paints, etc. In addition, vapor deposition involves no or minimal solvent emissions, making it more environmentally friendly.

Typically, the metal containing layer is thin and is preferably no greater than 500 pm. More preferably, it is greater than 30 nm. More preferably, the thickness is at least 50 nm.

Optionally prior to vapor deposition, the surface of the substrate can be pretreated by a plasma containing an inert gas and oxygen. It has been found that plasma pretreatment of the substrate followed by deposition of the metal coating leads to effective bonding within the laminate.

The metal-coated substrate may be impregnated with resin in the laminate assembly prior to the application of heat and pressure.

Alternatively, the metal-coated substrate may be incorporated into the laminate assembly using a “dry pressing” process, in which the metal-coated substrate is adjacent one or more impregnated resin layers. Upon application of heat and pressure, the resin of the impregnated sheet/s penetrates and fuses with the metal-coated substrate.

In another embodiment, the metal containing layer is applied to a finished laminate on an external surface thereof. Preferably the metal containing layer is applied by vapor deposition.

The metal-coated substrate preferably comprises an outer layer of the laminate. More preferably, the metal-coated side of the coated substrate faces outwardly of the laminate. Such an arrangement is particularly advantageous where the laminate of the invention is used for an EMI shielding construction requiring more than one laminate panel. In order to ensure continuous shielding there must be electrical conductivity between adjacent panels. This is typically effected by joining the laminate panels with electrically conductive fixings known to the art. Such a construction is facilitated by having the metal coating on the back surface of the laminate.

The metal-coated substrate may comprise any one or more of the layers of paper 25 comprising the LPL, HPL, or CPL. However, it is preferably an outer layer of the laminate.

The laminate of the invention may include more than one metal-coated layer in order to enhance the EMI shielding properties of the laminate. Advantageously the metal-coated layers are positioned adjacent or close to each other in the laminate.

The laminate may also include one or more polymer layers. The polymer is preferably one that is compatible with formaldehyde based resins, particularly with aminoformaldehyde and phenol-formaldehyde based resins. The polymer layer is preferably deposited by vapor deposition, more preferably by physical vapor deposition. Advantageously, the polymer layer is coated onto the surface of a substrate and may be subsequently coated with the metal-containing coating. In such an arrangement, the polymer coating assists in adhering the metal coating to the substrate and also protects the metal coating from damage and corrosion. Alternatively, or in addition, the polymer layer may form a coating on top of the metal-containing coating, which further assists in protecting the metal containing coating. The surface of the substrate may advantageously be primed prior to deposition of a polymer or metal-containing coating, preferably by treatment with a plasma.

In a preferred embodiment, the laminate includes a semi-permeable substrate, which is primed by plasma treatment. A polymer coating of about 0.5 pm thickness is deposited on the primed substrate with a metal-containing coating deposited onto the polymer coating. A second polymer coating of about 0.5 pm thickness is deposited on to the metal coating.

Other types of laminate to which the invention is applicable include those comprising one or more layers of paper laminated to a substrate able to withstand laminating conditions of temperature between 120 and 190° C. and a minimum of about 15 bar.

Such substrates include mineral, polymeric or composite substrates, such as a mineral board or polyester sheet or sheets made from sheet molding compound. The laminate can also extend to one or more layers of paper laminated to a wooden substrate such as a plywood substrate.

While the laminate of the invention inherently has some antistatic properties, these can be enhanced or turned into static dissipative properties by seeding the uncured resin/s used in making the laminate with conductive species such as conductive salts, carbon fibers or metallic particles. Preferably the conductive species is a conductive salt, more preferably an organic salt such as sodium formate. It is thought that organic salts are better compatible with preferred organic resins. Humectants may also be added to the resin to enhance electrical conductivity.

Typically, seeding entails adding the conductive salt to the uncured resin, preferably to the resin used to impregnate surface paper layers such as the overlay or decorative layers and layers interconnecting to the metallized layer.

Where it is desired that the laminate have anti-static properties, little or no salt may be required in the resin. Relatively higher quantities of salt may be required for static dissipative properties.

The charged species preferably conduct static electricity away from the surface of the 10 laminate via the resin to the metal-coated layer that is preferably earthed. Laminates having anti-static/dissipative properties are generally useful as bench tops or flooring where it is essential to prevent electrostatic charging. For example, in workplaces involved with manufacture or processing of electronic components, laboratories or facilities where explosive or combustible atmospheres are present.

It will now be convenient to describe the invention with reference to the following Example. The Example illustrates the manner in which the invention may be practiced, but it should be understood that the Example should not be considered limiting of the invention.

Example—A high-pressure laminate having electromagnetic shielding properties was manufactured in accordance with the invention. The laminate assembly comprised a decorative paper layer impregnated with melamine formaldehyde resin, four sub layers of Kraft paper impregnated with phenol formaldehyde resin and a backing layer of aluminum coated paper impregnated with melamine formaldehyde resin. The metal-coated paper comprised a 50 nm thick layer of aluminum deposited by PVD using thermal evaporation. The assembly was pressed at 143° C. and a specific pressure of 65 bar, giving an overall pressed thickness of 0.8 mm.

The EMI shielding effectiveness of the EMI shielding laminate was compared to that of other shielding materials.

The comparative shielding materials comprised:
1. Decoral®: a laminate comprising a relatively thick (approximately 0.5 mm) substrate layer of aluminium sheet to which is thermally fused two layers of resin impregnated papers, the top most layer being the decorative layer.
2. Brushed aluminum HPL: a high pressure laminate of substrate paper layers with a relatively thin (approximately 0.1 mm) layer of aluminum which forms the decorative surface of the laminate.
3. Carbon nanotube HPL a laminate incorporating carbon nanotubes within its structure and produced in accordance with copending Australian patent application number 2006202058.

Table 1 below sets out the measured surface resistance versus thickness of conductive 15 layer for each of the materials tested:

TABLE 1
Electrical Resistance vs Thickness of Conductive Layer

| | Thickness of Conductive | | Measured Surface |
|---|---|---|---|
| Material | Layer | | Resistance, ohm/sq |
| Decoral ® | 0.56 | mm | 1.9 |
| Brushed Aluminum HPL | 0.11 | mm | 0.63 |
| Carbon Nanotubes HPL | −50 | pm | 70 |
| Carbon Nanotubes HPL | −50 | pm | 100 |
| Inventive Laminate | 50 | nm | 5.1 |

As can be seen the surface resistance of the inventive laminate, having a conductive layer thickness of 50 nm, has a very low surface resistance of only 5.1 ohm/square. This is to be compared with the carbon nanotubes HPL that has a surface resistance about an order of magnitude higher, despite having a conductive layer thickness which is 3 orders of magnitude higher. While both Decoral and Brushed aluminum HPL have slightly lower surface resistances, both these laminates have a conductive layer thickness several orders of magnitude greater than the inventive laminate. Accordingly, the material costs alone in producing both of these laminates would be significantly higher for only a slight improvement in surface resistance.

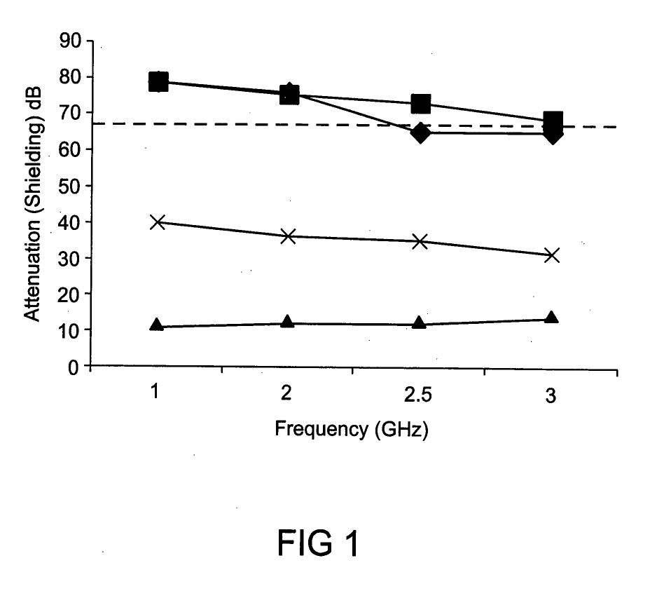

A comparison of the shielding effectiveness of each material is illustrated in FIG. 1, which plots attenuation dB against electromagnetic radiation frequency GHz for each material. The attenuation of the inventive laminate (crosses) ranges from around 30 to 40 dB over the radiation frequency range considered. This was twice to three times more effective than shielding provided by the carbon nanotubes I-IPL (triangles). While the shielding effectiveness of the inventive laminate at any particular frequency was approximately half that of either Decoral (diamonds) or Brushed aluminum HPL (squares), it must again be remembered that both of the latter materials have significantly thicker conductive layers which would more than account for the increased shielding effect. It is to be understood that various modifications, additions and/or alterations may be made to the laminates and methods previously described without departing from the present invention.

What is claimed is:

1. A laminate having electromagnetic shielding properties, said laminate including two or more layers adhered together with resin under application of heat and pressure, wherein at least one of said layers includes a substrate having deposited thereon a metal-containing coating.

2. A laminate according to claim 1, wherein the substrate is semi-permeable and may be paper, fabric or a textile, preferably the semi-permeable substrate is a paper, more preferably a paper that is conventionally used in the manufacture of decorative high-pressure laminates

3. A laminate according to claim 1, also having antistatic and/or static dissipative properties.

4. A laminate according to claim 1, wherein said laminate is a high-pressure laminate (I-IPL), a continuously pressed laminate (CPL) or a low pressure laminate (LPL).

5. A laminate according to claim 1, wherein said laminate is a decorative laminate.

6. A laminate according to claim 1, wherein said resin is selected from amino formaldehyde resins, phenolic resins, combinations of these resins, derivatives of these resins suitable for preparation of low pressure, continuously pressed and high pressure laminates, and resins or polymers that are compatible with formaldehyde-based resins.

7. A laminate according to claim 1, wherein the metal containing layer comprises aluminum.

8. A laminate according to claim 1, wherein the metal containing layer is permeable.

9. A laminate according to claim 1, wherein the metal containing layer is typically applied to the substrate by vapor deposition, preferably by physical vapor deposition (PVD), more preferably by PVD using an evaporator.

10. A laminate according to claim 1, wherein the metal containing layer is thin and is preferably no greater than 500 pm.

11. The laminate of claim 10, wherein the metal-containing layer has a thickness greater than 30 nm, preferably greater than 50 nm.

12. A laminate according to claim 1, wherein said substrate is pretreated by a plasma containing an inert gas and oxygen prior to deposition of said metal-containing coating.

13. A laminate according to claim 1, wherein the metal-coated substrate comprises an outer layer of said laminate, preferably within the metal-coated side of said substrate facing outwardly of the laminate.

14. A laminate according to claim 1, further including one or more polymer layers, said polymer preferably being compatible with formaldehyde based resins.

15. The laminate of claim 14, where one said polymer layer is coated onto the surface of said substrate prior to depositing said metal-containing coating.

16. The laminate of claim 14, wherein one said polymer layer is deposited onto the surface of the metal-containing coating.

17. The laminate of claim 14, wherein said one or more polymer layers have a thickness of 0.5 pm.

18. A method of manufacturing a laminate having electromagnetic shielding properties including the steps:
(a) depositing a metal-containing coating onto a substrate to form a metal coated substrate,
(b) incorporating said metal coated substrate into a laminate assembly having at least one other layer,
(c) adhering said metal coated substrate to said at least one other layer using a curable resin to form an adhered laminate assembly, and
(d) subjecting said adhered laminate assembly to heat and pressure to cure said resin and thereby form said laminate.

19. The method of claim 18, wherein said metal-containing coating is deposited onto said substrate by vapor deposition, preferably by PVD.

20. The method of claim 18, wherein the thickness of said metal-containing layer is between 30 nm and 500 pm, preferably between 50 nm and 500 pm.

21. The method of claim 18, wherein said substrate is pretreated with a plasma prior to deposition of said metal-containing coating, said plasma preferably containing an inert gas and oxygen.

22. The method of claim 18, wherein the metal-coated substrate is impregnated with said curable resin prior to incorporating it into said laminate assembly.

23. The method of claim 18, wherein the metal coated substrate is incorporated into the laminate assembly using a “dry pressing” process, in which the metal coated substrate is adjacent one or more impregnated resin layers and upon application of heat and pressure, the resin of the impregnated sheet(s) penetrates and fuses with the metal-coated substrate.

24. The method of claim 18, wherein the adhered laminate assembly is subjected to a specific pressure of from about 15 to 40 bar and a temperature between 130° C. and 180° C., to form a low pressure laminate.

25. The method of claim 18, wherein the adhered laminate assembly is subjected to a specific pressure of greater than 50 bar, preferably between 60 and 100 bars, and a temperature between 120° C. and 160° C., to form a high-pressure laminate.

26. The method of claim 18, wherein the adhered laminate assembly is subjected to a specific pressure from 15 to 80 bar and a temperature from 120° C. and 160° C., and is formed on a continuous double belted press to produce a continuously pressed laminate.

27. The method of claim 18, further including the step of depositing a polymer layer onto the substrate prior to step (a).

28. The method of claim 18, further including the step of depositing a polymer layer onto the metal-containing coating.

29. The method of claim 18, further including seeding said curable resin with conductive species such as conductive salts, carbon fibers or metallic particles.

30. The method of claim 29, where the conductive salt is an organic salt, preferably sodium formate.

31. A method of manufacturing a laminate having electromagnetic shielding properties including the step of depositing a metal containing coating onto a surface of a laminate.
